(19) United States
(12) Patent Application Publication
(10) Pub. No.: US 2011/0276391 A1
(43) Pub. Date: Nov. 10, 2011

(54) EXPANSION OF TERM SETS FOR USE IN ADVERTISEMENT SELECTION

(75) Inventors: Dustin Hillard, San Francisco, CA (US); Chris Leggetter, Belmont, CA (US); Eren Manavoglu, Menlo Park, CA (US)

(73) Assignee: Yahoo! Inc., Sunnyvale, CA (US)

(21) Appl. No.: 12/774,471

(22) Filed: May 5, 2010

(51) Int. Cl. G06Q 30/00; G06Q 10/00

(52) U.S. Cl. 705/14.43; 705/14.45

(57) ABSTRACT

Techniques are provided for use in online advertisement selection in response to a search query. Techniques are provided in which historical online advertising information is obtained. Segmentation is performed of advertisements and queries and used in generating segment pairs, and an associated advertisement performance is determined for each pair. Segmentation is also performed of a particular query and a candidate advertisement for selection to be served in response, and using the resulting segments, pairs are identified and used in adding to a term set associated with the candidate advertisement, which term set is used in assessing the advertisement for selection.

### BACKGROUND

In sponsored search, advertisements are selected based on search queries as well as being targeted in many other ways. It is sought to select advertisements that will be high-performing, such as by leading to high click through rates, for example. Generally, terms, such as words or phrases, in a search query, as well as words in candidate advertisements, are used in the selection of an advertisement to serve in response to a query. Term sets, which may also be called “documents”, may be obtained or derived from advertisements, and queries may be used in this regard, and term weighting, to emphasize different terms to different degrees, may also be utilized. For instance, advertisement documents may include terms derived from various elements of an online advertisement, such as the title, description and display URL. In many situations, better term sets, which could include terms and/or weighting, can lead to better advertisement performance, increasing profit for several parties involved, as well as increasing advertiser and user satisfaction.

There is a need for techniques for obtaining term sets, such as advertisement documents, for use in advertisement selection.

### SUMMARY

Some embodiments of the invention provide methods and systems for use in online advertisement selection in response to a search query. Techniques are provided in which historical online advertising information is obtained (which can include information relating to any online advertising that has occurred). Segmentation is performed of advertisements and queries and used in generating segment pairs, and an associated advertisement performance is determined for each pair. Segmentation is also performed of a particular query and a candidate advertisement for selection to be served in response to the search query, and using the resulting segments, pairs are identified and used in adding to a term set associated with the candidate advertisement, which term set can be used in assessing the candidate advertisement for selection.

It is to be understood that, while the invention is described herein primarily with reference to segmentation of advertisements and queries, some embodiments of the invention do not require or utilize segmentation in connection with advertisements, queries, or both. For example, in some embodiments, a whole advertisement, or non-segmented portion of an advertisement, rather than segments thereof, can be used in techniques for deriving terms to add to ad documents.

It is further to be understood that some embodiments of the invention contemplate use of any of various techniques to derive, mine for, or generate new terms, such as mining from organic search results, mining from landing pages associated with advertisements, etc.

It is further to be understood that techniques according to embodiments of the invention can be used for many purposes and applications beyond those which are described in detail herein, such as, for example, using derived or discovered terms, etc., in Web search and retrieval and ranking.

In some embodiments, query terms or segments of the identified pairs are used in adding to the term set associated with the candidate advertisement.

In some embodiments, each term, or added term, of the term set is weighted based at least in part on associated advertisement performance of the second set of information. The weight of a term affects the degree to which the term is weighted with respect to the selection of the candidate advertisement.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention; and

FIG. 4 is a flow diagram illustrating a method according to one embodiment of the invention.

While the invention is described with reference to the above drawings, the drawings are intended to be illustrative, and the invention contemplates other embodiments within the spirit of the invention.

### DETAILED DESCRIPTION

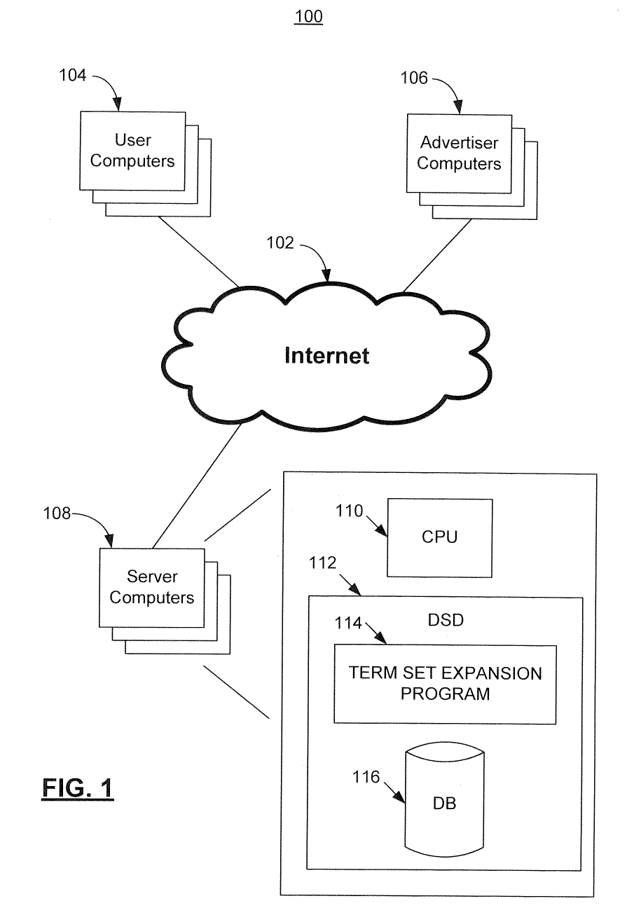

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Term Set Expansion Program 114.

The Program 114 is intended to broadly include all programming, applications, algorithms, software and other and tools necessary to implement or facilitate methods and systems according to embodiments of the invention, including expansion techniques, enhancement techniques, and/or other techniques. The elements of the Program 114 may exist on a single server computer or be distributed among multiple computers or devices. In some embodiments or instances, the Program 114 may be used in weighting terms, and not adding terms.

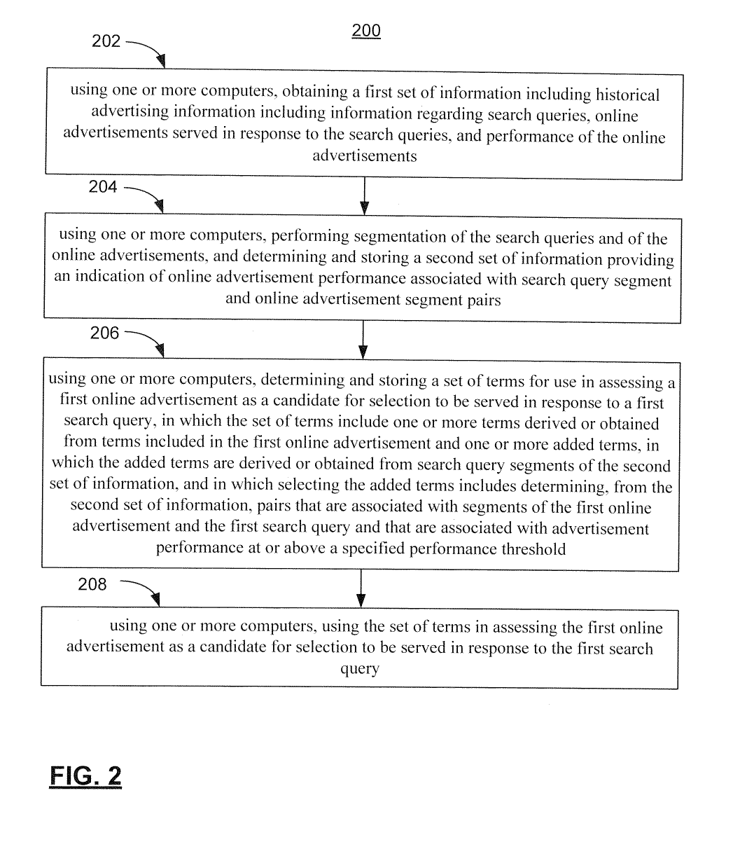

FIG. 2 is a flow diagram illustrating a method 200 according to one embodiment of the invention. At step 202, using one or more computers, a first set of information is obtained, including historical advertising information including information regarding search queries, online advertisements served in response to the search queries, and performance of the online advertisements.

At step 204, using one or more computers, segmentation is performed of the search queries and of the online advertisements, and a second set of information is stored that provides an indication of online advertisement performance associated with search query segment and online advertisement segment pairs.

At step 206, using one or more computers, a set of terms is determined and stored for use in assessing a first online advertisement as a candidate for selection to be served in response to a first search query. The set of terms includes one or more terms derived or obtained from terms included in the first online advertisement and one or more added terms. The added terms are derived or obtained from search query segments of the second set of information. Selecting the added terms includes determining, from the second set of information, pairs that are associated with segments of the first online advertisement and the first search query and that are associated with advertisement performance at or above a specified performance threshold.

At step 208, using one or more computers, the set of terms is used in assessing the first online advertisement as a candidate for selection to be served in response to the first search query.

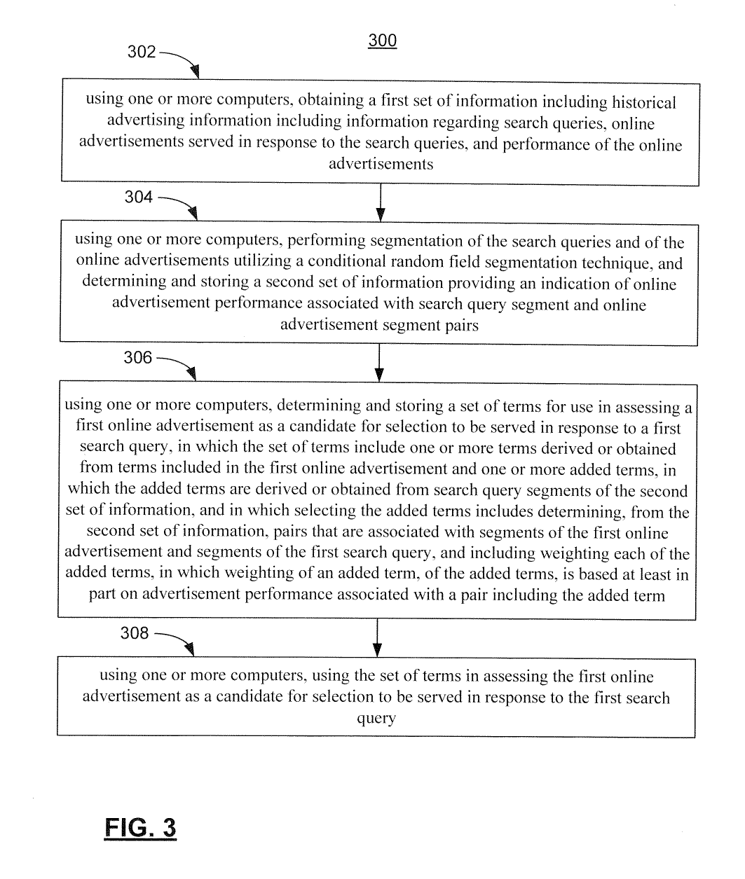

FIG. 3 is a flow diagram illustrating a method 300 according to one embodiment of the invention. Step 302 of the method 300 is similar to step 202 of the method 200 depicted in FIG. 2.

At step 304, using one or more computers, segmentation is performed of the search queries and of the online advertisements utilizing a Conditional Random Field (CRF) segmentation technique, and a second set of information is determined and stored that provides an indication of online advertisement performance associated with search query segment and online advertisement segment pairs.

At step 306, using one or more computers, a set of terms is determined and stored for use in assessing a first online advertisement as a candidate for selection to be served in response to a first search query. The set of terms include one or more terms derived or obtained from terms included in the first online advertisement and one or more added terms. The added terms are derived or obtained from search query segments of the second set of information. Selecting the added terms includes determining, from the second set of information, pairs that are associated with segments of the first online advertisement and segments of the first search query. Each of the added terms is weighted based at least in part on advertisement performance associated with a pair including the added term.

At step 308, using one or more computers, the set of terms is used in assessing the first online advertisement as a candidate for selection to be served in response to the first search query.

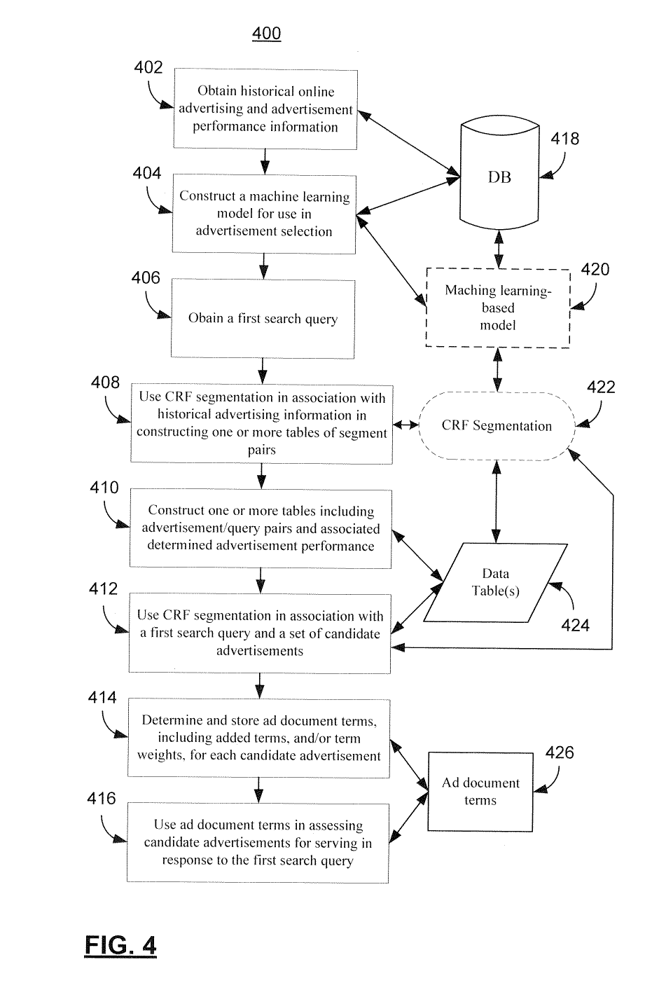

FIG. 4 is a flow diagram illustrating a method 400 according to one embodiment of the invention. At step 402, historical online advertising and advertisement performance information is obtained and stored in one or more databases, such as database 418.

At step 404, a machine learning model 420 is constructed for use in advertisement selection.

At step 406, a first search query is obtained.

At step 408, a Conditional Random Field (CRF) segmentation technique 422 is used in association with historical advertising information in constructing one or more tables of segment pairs.

At step 410, one or more data tables 424 are constructed including advertisement/query pairs and associated determined advertisement performance.

At step 412, a Conditional Random Field segmentation technique 422 is used in association with a first search query and a set of candidate advertisements.

At step 414, ad document terms 426 are determined and stored, including added terms, and/or term weights, for each candidate advertisement.

At step 416, the ad document terms 426 are used in assessing candidate advertisements for serving in response to the first search query.

Some embodiments of the invention provide techniques for adding to or supplementing, and/or weighting, ad documents, or term sets used in assessing candidate advertisements for serving in response to a search query, which can include equivalent serving opportunities, other equivalents, etc.

Advertisements such as sponsored search advertisements generally include a creative, which includes a title, description and a display URL. Advertisements may be selected for serving in response to term-based search queries, such as user-entered search queries. Although many forms of targeting may be utilized, selection is generally based at least in part on terms included in the advertisement, such as in the creative, in some cases, just the title.

Some embodiments of the invention recognize, however, that increasing or optimizing advertisement performance, such as click through rate, is of great importance. To this end, some embodiments incorporate the use of historical advertising information, including, for example, recent advertisements served, associated queries, and the performance of the particular advertisements after being served in response to particular queries. For instance, it is recognized that particular advertisements, associated with a particular ad document, such as title terms, have particular associated performance levels when served in response to particular queries containing particular terms. It is further recognized that this information can be mined and used in supplementing or enhancing the ad document, by, for example, recognizing queries associated with high performance of particular advertisements, and using terms from the query to add to the ad document, and/or weighting added or existing ad document terms to reflect associated advertisement performance. Generally, machine learning models, or output or tables, for example, from such models, can be used to analyze, mine or process this information for use in assessing candidate advertisements for selection for serving in response to a particular query.

Some embodiments of the invention further recognize, however, that segmentation of term sets associated with advertisements and queries can be used to increase the granularity and applicability, and to magnify the benefit, of this type of approach. Specifically, for instance, using segmentation, along with data mining, particular segments (including, for example, a term or group of terms) of advertisements and queries can be associated with particular advertisement performance levels. This information can be stored, such as in a table or tables. For a particular user query, for instance, the query can be segmented. The segments can then be used to identify particular associated or similar query segments from the table, such as query segments that are considered confident translations of segments in the user query, such as with a particular associated level of confidence. Reasonable or confident translations may also be used in various other aspects of some embodiments of the invention, in connection with associating segments or terms of term sets, such as query or advertisement term sets. It is noted that, as used herein, obtaining a term or segment, for instance, can include using the term or segment, and that deriving a term or segment, for instance, can include use of translations, or using translations associated with a determined high enough degree of certainty or confidence.

Although various techniques for segmentation are contemplated, some embodiments of the invention utilized Conditional Random Field (CRF) segmentation.

In some embodiments, once such advertisement segment/query segment pairs have been identified, the table will provide associated advertisement performance levels, based at least in part on mined and parsed historical advertising information, such as information from the last one or several months, for instance. This information can then be used in selecting or weighting ad document terms accordingly.

For instance, in some embodiments, based on the associated pairs and corresponding advertisement performance level, terms may be added to the ad document. For instance, in some embodiments, if, for a particular pair, associated advertisement performance is at or above a certain threshold level, then terms from the query of the pair are added to the ad document associated with the advertisement, for use in assessing the advertisement as a candidate for serving in response to the query.

In some embodiments, based on the associated pairs and corresponding advertisement performance level, weighting may be determined for particular segments or terms of the ad document. For instance, in some embodiments, terms from some or all associated pairs are added to the ad document, with weighting that corresponds or otherwise relates to the advertisement performance level associated with that pair. In some embodiments, the terms and their associated weights are utilized in association with a machine learning model, or information from a machine learning model, in assessing the advertisement as a candidate for serving in response to the particular query. For instance, higher weightings of terms may lead to greater emphasis or importance of those terms in the assessment and selection process.

Furthermore, some embodiments or instances of use of the invention include weighting of existing ad document terms, even if no new terms are added. Still further, some embodiments or instances of use may include addition of terms and weighting of terms, including the new terms or all terms, of the ad document.

Some embodiments of the invention particularly contemplate using the title portion of the advertisement creative. However, other embodiments are contemplated, such as embodiments that utilize and segment other portions of the creative, or combinations, or other aspects of the advertisement, or even other aspects of non-advertisement texts associated or determined to be associated with the advertisement in some way.

Some embodiments of the invention include adding to ad documents using terms from queries. However, some embodiments of the invention contemplate various other sources of terms for determining to add to ad documents, including other advertisement terms, or other sources entirely, in which the terms or segments from the sources may be added if associated with sufficiently high advertisement performance, or in which the terms may be added and weighted, or just weighted, in accordance with such performance. Furthermore, in addition to advertisement segment/query segment pairs, other types of pairs and sources for pairs are contemplated, and even groups of more than two items.

While the invention is described with reference to the above drawings, the drawings are intended to be illustrative, and the invention contemplates other embodiments within the spirit of the invention.

1. A method comprising:
using one or more computers, obtaining a first set of information comprising historical advertising information including information regarding search queries, online advertisements served in response to the search queries, and performance of the online advertisements;
using one or more computers, performing segmentation of the search queries and of the online advertisements, and determining and storing a second set of information providing an indication of online advertisement performance associated with search query segment and online advertisement segment pairs;
using one or more computers, determining and storing a set of terms for use in assessing a first online advertisement as a candidate for selection to be served in response to a first search query, wherein the set of terms comprises one or more terms derived or obtained from terms included in the first online advertisement and one or more added terms, wherein the added terms are derived or obtained from search query segments of the second set of information, and wherein selecting the added terms comprises determining, from the second set of information, pairs that are associated with segments of the first online advertisement and the first search query and that are associated with advertisement performance at or above a specified performance threshold; and
using one or more computers, using the set of terms in assessing the first online advertisement as a candidate for selection to be served in response to the first search query.

2. The method of claim 1, wherein performing segmentation comprises utilizing a Conditional Random Field segmentation technique.

3. The method of claim 1, wherein the set of terms, including the added terms, are utilized in association with one or more machine learning models, or output of the one or more machine learning models, in connection with assessing the first online advertisement as a candidate for selection to be served in response to the first search query.

4. The method of claim 1, wherein the added terms are derived or obtained from search query terms of the pairs that are associated with segments of the first online advertisement and the first search query and that are associated with advertisement performance at or above a specified performance threshold.

5. The method of claim 1, comprising weighting each of the added terms based on associated advertisement performance of the second set of information, wherein the weight of each of the added terms affects the degree to which each of the added terms is weighted with respect to assessing the first online advertisement for selection to be served in response to the first search query.

6. The method of claim 1, comprising determining whether to select the first online advertisement for serving in response to the first search query based at least in part on whether the first online advertisement scores high enough in association with a machine learning-based model or output of a machine learning-based model, based at least in part on the set of terms including the added terms.

7. The method of claim 1, comprising, after selecting the first online advertisement for serving in response to the first search query, facilitating serving of the first online advertisement in response to the first search query.

8. The method of claim 1, comprising, after selecting the first online advertisement for serving in response to the first search query, actually serving the first online advertisement in response to the first search query.

9. The method of claim 1, wherein obtaining the historical advertising information comprises obtaining historical advertising information relating to recent period in time.

10. A system comprising:
one or more server computers coupled to a network; and
one or more databases coupled to the one or more server computers;
wherein the one or more server computers are for:
obtaining a first set of information comprising historical advertising information including information regarding search queries, online advertisements served in response to the search queries, and performance of the online advertisements;
performing segmentation of the search queries and of the online advertisements, and determining and storing a second set of information providing an indication of online advertisement performance associated with search query segment and online advertisement segment pairs;
determining and storing a set of terms for use in assessing a first online advertisement as a candidate for selection to be served in response to a first search query, wherein the set of terms comprises one or more terms derived or obtained from terms included in the first online advertisement and one or more added terms, wherein the added terms are derived or obtained from search query segments of the second set of information, and wherein selecting the added terms comprises determining, from the second set of information, pairs that are associated with segments of the first online advertisement and segments of the first search query, and comprising weighting each of the added terms, wherein weighting of an added term, of the added terms, is based at least in part on advertisement performance associated with a pair including the added term; and
using one or more computers, using the set of terms in assessing the first online advertisement as a candidate for selection to be served in response to the first search query.

11. The system of claim 10, wherein at least one or the one or more server computers is coupled to the Internet.

12. The system of claim 10, wherein selecting the added terms comprises determining, from the second set of information, pairs that are associated with segments of the first online advertisement and the first search query and that are associated with advertisement performance at or above a specified performance threshold.

13. The system of claim 10, wherein performing segmentation comprises utilizing a Conditional Random Field Segmentation technique.

14. The system of claim 10, wherein the set of terms, including the added terms, are utilized in association with one or more machine learning models, or output of the one or more machine learning models, in connection with assessing the first online advertisement as a candidate for selection to be served in response to the first search query.

15. The system of claim 10, wherein the added terms are derived or obtained from search query terms of the pairs that are associated with segments of the first online advertisement and the first search query and that are associated with advertisement performance at or above a specified performance threshold.

16. The system of claim 10, comprising weighting each of the added terms based on associated advertisement performance of the second set of information, wherein the weight of each of the added terms affects the degree to which each of the terms is weighted with respect to assessment for selection of the first online advertisement to be served in response to the first search query.

17. The system of claim 10, comprising, after selecting the first online advertisement for serving in response to the first search query, facilitating serving of the first online advertisement in response to the first search query.

18. The method of claim 1, comprising after selecting the first online advertisement for serving in response to the first search query, actually serving the first online advertisement in response to the first search query.

19. The system of claim 10, comprising using the set of terms as input to a machine learning-based model used in advertisement selection.

20. A computer readable medium or media containing instructions for executing a method comprising:
using one or more computers, obtaining a first set of information comprising historical advertising information including information regarding search queries, online advertisements served in response to the search queries, and performance of the online advertisements;
using one or more computers, performing segmentation of the search queries and of the online advertisements utilizing a Conditional Random Field segmentation technique, and determining and storing a second set of information providing an indication of online advertisement performance associated with search query segment and online advertisement segment pairs;
using one or more computers, determining and storing a set of terms for use in assessing a first online advertisement as a candidate for selection to be served in response to a first search query, wherein the set of terms comprises one or more terms derived or obtained from terms included in the first online advertisement and one or more added terms, wherein the added terms are derived or obtained from search query segments of the second set of information, and wherein selecting the added terms comprises determining, from the second set of information, pairs that are associated with segments of the first online advertisement and segments of the first search query, and comprising weighting each of the added terms, wherein weighting of an added term, of the added terms, is based at least in part on advertisement performance associated with a pair including the added term; and
using one or more computers, using the set of terms in assessing the first online advertisement as a candidate for selection to be served in response to the first search query.
